(19) United States
(12) Patent Application Publication
(10) Pub. No.: US 2011/0184723 A1
(43) Pub. Date: Jul. 28, 2011

(54) PHONETIC SUGGESTION ENGINE

(75) Inventors: Chao Huang, Beijing (CN); Xuguang Xiao, Suizhou (CN); Jing Zhao, Beijing (CN); Gang Chen, Beijing (CN); Frank Kao-Ping Soong, Beijing (CN); Matthew Robert Scott, Beijing (CN)

(73) Assignee: MICROSOFT CORPORATION, Redmond, WA (US)

(21) Appl. No.: 12/693,316

(22) Filed: Jan. 25, 2010

(51) Int. Cl. G06F 17/20; G09B 5/00

(52) U.S. Cl. 704/8; 434/169

(57) ABSTRACT

A phonetic suggestion engine for providing word or phrase suggestions for an input letter string initially converts an input letter string into one or more query phoneme sequences. The conversion is performed via at least one standardized letter-to-sound (LTS) database. The phonetic suggestion engine further obtains a plurality of candidate phoneme sequences that are phonetically similar to the at query phoneme sequences from a pool of potential phoneme sequences. The phonetic suggestion engine then prunes the plurality of candidate phoneme sequences to generate scored phoneme sequences. The phonetic suggestion engine subsequently generates a plurality of ranked word or phrase suggestions based on the scored phoneme sequences.

### BACKGROUND

A spell checker for a particular language is capable of checking for spelling errors, such as common typographical errors. The spell checker may offer suggestions of correct spellings for a misspelled word. However, users who are unfamiliar with a particular language may attempt to spell words based on the spelling rules or pronunciation norms of their native language. In these situations, current spell checker algorithms may be unable to process these spelling mistakes and produce useful suggestions for the correct spelling of an intended word.

### SUMMARY

Described herein are techniques and systems for using a phonetic suggestion engine that analyzes phonetic similarity between misspelled words and intended words to suggest the correct spellings of the intended words. In many instances, an inputted misspelling of a word may be distantly related to the correct spelling, but phonetically. Thus, the use of a phonetic suggestion engine, as described herein, may enable non-native speakers and/or language learners of a particular language to leverage their phonetic knowledge to obtain the proper spelling of a desired word. The phonetic suggestion engine may also augment conventional spelling checkers to enhance language learning and expression.

The phonetic suggestion engine may initially use one or more letters-to-sound (LTS) databases to convert an input letter string into phonemes, or segments of sound that form meaningful contrasts between utterances. Subsequently, the phonemes may be further pruned and scored to match candidate words or phrases from a particular language dictionary. The matched candidate words or phrases may be further ranked according to one or more scoring criteria to produce a ranked list of word suggestions or phrase suggestions for the input letter string.

In at least one a, a phonetic suggestion engine initially converts an input letter string into query phoneme sequences. The conversion is performed via at least one standardized LTS database. The phonetic suggestion engine further obtains a plurality of candidate phoneme sequences that are phonetically similar to the at query phoneme sequences from a pool of potential phoneme sequences. The phonetic suggestion engine then prunes the plurality of candidate phoneme sequences to generate scored phoneme sequences. The phonetic suggestion engine subsequently generates a plurality of ranked word or phrase suggestions based on the scored phoneme sequences.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 is a block diagram of an illustrative scheme that implements a phonetic suggestion engine for providing word or phrase suggestions for an input letter string, in accordance with various embodiments.

FIG. 2 is a block diagram of selected components of an illustrative phonetic suggestion engine that provides word or phrase suggestions for an input letter string, in accordance with various embodiments.

FIG. 3 is a flow diagram of an illustrative process to generate word or phrase suggestions for an input letter string, in accordance with various embodiments.

FIG. 4 shows an illustrative web page that facilitates the provision of word or phrase suggestions for an input letter string, in accordance with various embodiments.

FIG. 5 is a flow diagram of an illustrative process to perform fast matching to obtain candidate phoneme sequences from a pool of phoneme sequences, in accordance with various embodiments.

FIG. 6 is a flow diagram of an illustrative process to rank scored candidate phoneme sequences using at least one scoring criteria, in accordance with various embodiments.

FIG. 7 is a block diagram of an illustrative electronic device that implements phonetic suggestion engines.

### DETAILED DESCRIPTION

The embodiments described herein pertain to the use of a phonetic suggestion engine to provide word or phrase suggestion for an input letter string. The input letter string may include the misspelling of an intended word or phrase that is distantly related to the actual spelling of the intended word or phrase, but is phonetically similar to the intended word or phrase.

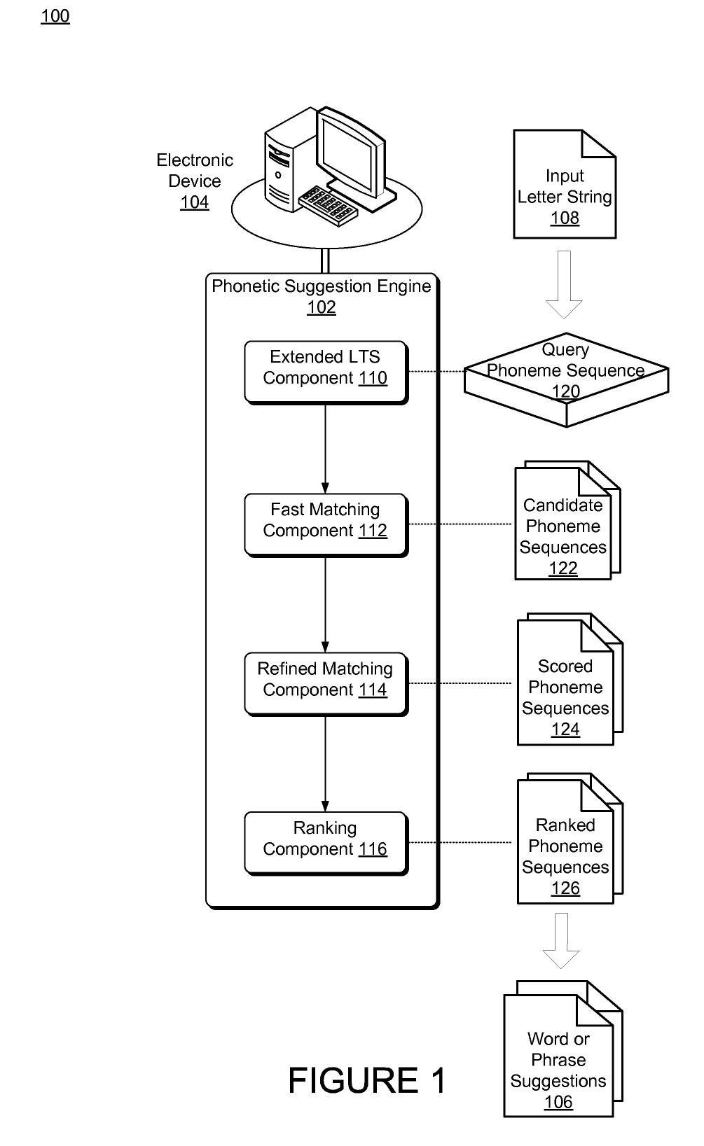

The phonetic suggestion engine may convert the input letter string to a sequence of phonemes. The phonetic suggestion engine may then match the sequence of phonemes to a pool of candidate phoneme sequences. Each of the candidate phoneme sequences in the pool may correspond to a correctly spelled word or phrase. Accordingly, by further refining the phoneme matching, the phoneme suggestion engine may provide word or phrase suggestions for the input letter string. Various example implementation of the phonetic suggestion engine in accordance with the embodiments are described below with reference to FIGS. 1-7.

### Illustrative Environment

FIG. 1 is a block diagram that illustrates an example scheme that implements a phonetic suggestion engine 102 to provide word or phrase suggestions for an input letter string, in accordance with various embodiments.

The phonetic suggestion engine 102 may be implemented on an electronic device 104. The electronic device 104 may be a portable electronic device that includes one or more processors that provide processing capabilities and a memory that provides data storage/retrieval capabilities. In various embodiments, the electronic device 104 may be an embedded system, such as a smart phone, a personal digital assistant (PDA), a general purpose computer, such as a desktop computer, a laptop computer, a server, or the like. Further, the electronic device 104 may have network capabilities. For example, the electronic device 104 may exchange data with other electronic devices (e.g., laptops computers, servers, etc.) via one or more networks, such as the Internet. In additional embodiments, the phonetic suggestion engine 102 may be implemented on a plurality of electronic devices 104, such as a plurality of servers of one or more data centers (DCs) or one or more content distribution networks (CDNs).

The phonetic suggestion engine 102 may ultimately provide word or phrase suggestions 106 for the input letter string 108. In various embodiments, the phonetic suggestion engine 102 may include one or more updateable language-specific components (e.g., dictionaries, letter-to-sound converters, letter-to-sound correlation databases, and/or the like) that are specific to different languages. Thus, depending on its language configuration, the phonetic suggestion engine 102 may provide word or phrase suggestions in different languages for the same input letter string 108. For example, when the phonetic suggestion engine 102 is equipped with English components, the phonetic suggestion engine 102 may provide English word or term suggestions for a particular input string 108. However, when the phonetic suggestion engine 102 is equipped with French components, the phonetic suggestion engine 102 may provide French word or term suggestion for the same particular input string 108.

The input letter string 108 may be inputted into the phonetic suggestion engine 102 as electronic data (e.g., ACSCII data). The input letter string 108 may be inputted into the phonetic suggestion engine 102 via a user interface (e.g., web browser interface, application interface, etc.). In embodiments in which the user interface is a web browser interface, the phonetic suggestion engine 102 may reside on a server, and the input letter string 108 may be inputted to the phonetic suggestion engine 102 over the one or more networks from another electronic device (e.g., a desktop computer, a smart phone, a PDA, and the like). In turn, the phonetic suggestion engine 102 may output the plurality of word or phrase suggestions 106 via the corresponding user interface. In some embodiments, the plurality of word or phrase suggestions 106 may be further stored in the electronic device 104 for subsequent retrieval, analysis, and/or display.

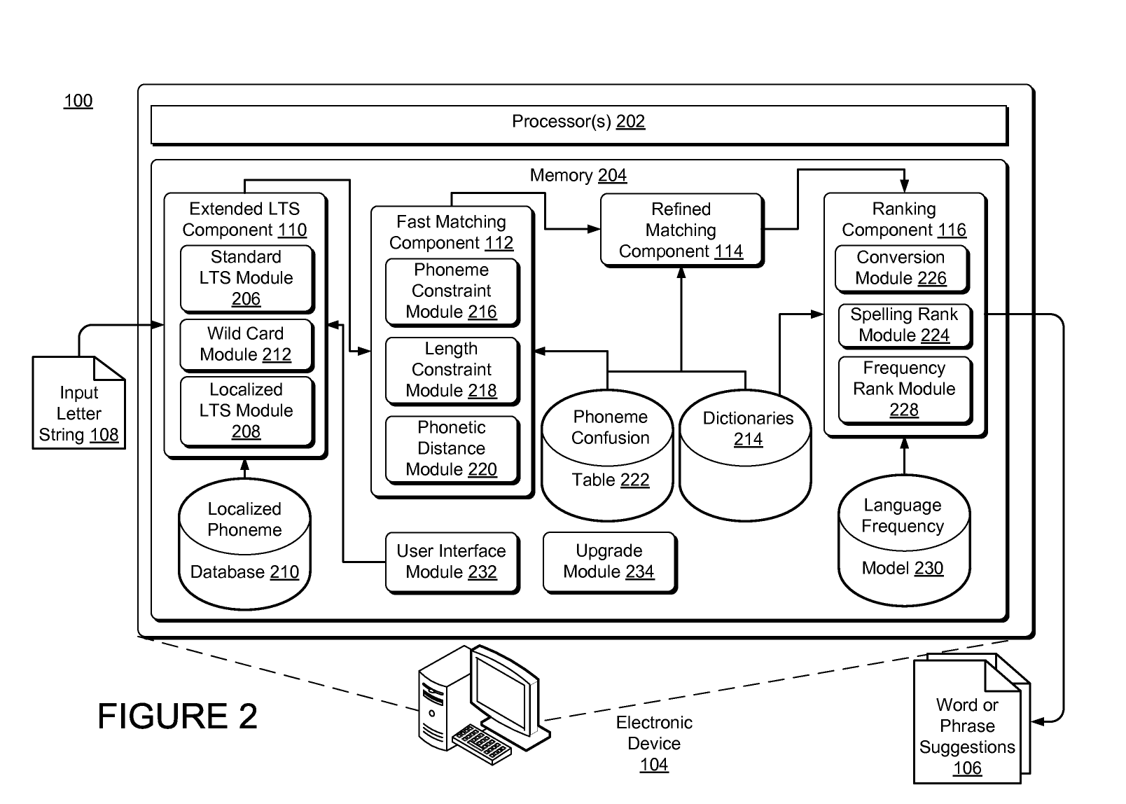

The phonetic suggestion engine 102 may include an extended letters-to-sound (LTS) component 110, a fast matching component 112, a refined matching component 114, and a ranking component 116. As further explained with respect to FIG. 2, the various components may include modules, or routines, program instructions, objects, and/or data structures that perform particular tasks or implement particular abstract data types.

The phonetic suggestion engine 102 may use the extended LTS component 110 to convert the input letter string 108 into a sequence of phonemes as a query phoneme sequence 120. In various embodiments, the LTS component 110 may be configured to generate a language-specific instance of the query phoneme sequence 120 for the input letter string 108. For example, but not as a limitation, the LTS component 110 may be tailored to convert the input letter string 108 into English phonemes. However, in other instances, the LTS component 110 may be tailored to convert the input letter string 108 into other languages (e.g., French, German, Japanese, etc.).

The phonetic suggestion engine 102 may use the fast matching component 112 to identify candidate phoneme sequences 122 from a pool of phoneme sequences that may match the query phoneme sequence 120. The pool of phoneme sequences may be from a standardized language reference resource, such as a dictionary. In some embodiments, the fast matching component 112 may identify the candidate phoneme sequences 122 by applying one or more pruning constraints. In other embodiments, the fast matching component 112 may identify the candidate phoneme sequences 122 by comparing the phonetic distance between the phonemes in the query phoneme sequence 120 and the phonemes in each of the candidate phoneme sequences 122. In further embodiments, the fast matching component 112 may use both the one or more pruning constraints and the phonetic distance comparison to identify the candidate phoneme sequences 122.

In various embodiments, the phonetic suggestion engine 102 may use the refined matching component 114 to eliminate one or more sequences of the candidate phoneme sequences 122. The elimination by the phonetic suggestion engine 102 may generate scored candidate phoneme sequences 124. In various embodiments, the refined matching component 114 may eliminate the one or more sequences by performing a Dynamic Programming (DP)-based sequence alignment. It will be appreciated that Dynamic Programming is a mathematical optimization method that is well suited for finding alignments, that is, similarity, between different sequences of data.

The ranking component 116 of the phonetic suggestion engine 102 may rank the scored candidate phoneme sequences 124 based on one or more scoring criteria. For example, but not as a limitation, each of the scored candidate phoneme sequences 124 may be ranked to create a relative match proximity to the input letter string 108. In various embodiments, the one or more scoring criteria may include the frequency that each of the scored candidate phoneme sequences 124 is used in a contemporary environment, the phonetic score generated by the DP-based sequence alignment, as well as other factors. Thus, with the application of ranking, the rank component 114 may sort the scored candidate phoneme sequences 124 into ranked candidate phoneme sequences 126.

Subsequently, the phonetic suggestion engine 102 may use the conversion component 110 to convert the ranked candidate phoneme sequences 126 into word or phrase suggestions 106. In various embodiments, the phonetic suggestion engine 102 may perform the conversion using a standardized language reference resource, such as a dictionary.

### Example Components

FIG. 2 is a block diagram that illustrates selected components of an example phonetic suggestion engine that provides word or phrase suggestions for an input letter string, in accordance with various embodiments.

The selected components may be implemented on the electronic device 104 (FIG. 1) that may include one or more processors 202 and memory 204. The memory 204 may include volatile and/or nonvolatile memory, removable and/or non-removable media implemented in any method or technology for storage of information, such as computer-readable instructions, data structures, program modules or other data. Such memory may include, but is not limited to, random access memory (RAM), read-only memory (ROM), electrically erasable programmable read-only memory (EEPROM), flash memory or other memory technology; CD-ROM, digital versatile disks (DVD) or other optical storage; magnetic cassettes, magnetic tape, magnetic disk storage or other magnetic storage devices; and RAID storage systems, or any other medium which can be used to store the desired information and is accessible by a computer system. Further, the components may be in the form of routines, programs, objects, and data structures that cause the performance of particular tasks or implement particular abstract data types.

The memory 204 may store components of the phonetic suggestion engine 102. The components, or modules, may include routines, programs instructions, objects, and/or data structures that perform particular tasks or implement particular abstract data types. As described above with respect to FIG. 1, the components may include the extended letter-to-sound (LTS) component 110, the fast matching component 112, the refined matching component 114, and the ranking component 116, each discussed in turn.

### Extended LTS Component

The extended LTS component 110 may receive and process the input letter string 108 into a sequence of phonemes, such as the query phoneme sequence 120. In various embodiments, the extended LTS component 110 may include a standard LTS module 206 and a localized LTS module 208 that perform phoneme processing. The standard LTS module 206 may be language-specific. For example, if the extended LTS component 110 is intended to suggest English terms and phrases for the input letter string 108, the standard LTS module 206 may be configured to extract an English sequence of phonemes 120 from the input letter string 108. Alternatively, the standard LTS module 206 may include multi-language phoneme generation capability.

The extended LTS component 110 may further use the localized LTS module 208 to compensate for foreign, ethnic, or regional accents. For example, the American English inflected with a traditional “Boston” accent is non-rhotic, in other words, the phoneme [r] may not appear at end of a syllable or immediately before a consonant. For example, the phoneme [r] may be missing from words like “park” or “car”. Thus, when the input letter string “ka” is inputted into phonetic suggestion engine 102, the extended LTS component 110 may use the localized LTS module 208 to generate a sequence of phonemes that corresponds to “car.”

The localized LTS module 208 may also be used to compensate for transliterations that are performed by non-native language users. For example, the Chinese language contains many transliterations of English proper nouns. A typical transliteration is the conversion of the English name “Elizabeth” into a Chinese Pinyin equivalent “elisabai”. Thus, when the input letter string “elisabai” is inputted into the phonetic suggestion engine 102 by a Chinese speaker as an English word, the extended LTS component 110 may use the localized LTS module 208 to recognize “elisabai” is intended to be the phonetic equivalent of “Elizabeth.” In other embodiments, the localized LTS module 208 may also contain transliterations for other out-of-vocabulary words, i.e., newly created words that are not found in a standard dictionary.

The localized LTS module 208 may perform accent and transliteration compensation functions using a localized phoneme database 210. In various embodiments, the localized phoneme database 210 may include one or more abstraction rules and/or one or more transliteration correlation tables that facilitate the compensation functions. For example, but not as a limitation, the localized phoneme database 210 may include a rule that compensates for the non-rhotic nature of the American Boston accent by adding the phoneme [r] for certain syllable endings or before certain consonants. In another non-limiting example, the localized phoneme database 210 may include a transliteration table that correlates the Chinese transliteration “elisabai” with “Elizabeth.” In at least some embodiments, the localized phoneme database 210 may be specific to a single language or accent. However, in various embodiments, the localized phoneme database may include abstraction rules and transliteration correlation tables for multiple languages.

The extended LTS component 110 may be further configured to receive user preference with respect to native language and accent preferences. Therefore, in instances where the localized phoneme database 210 is multi-lingual, the extended LTS component 110 may command the localized LTS module 208 to use the appropriate language data in the localized phoneme database 210. The appropriate language data may be used to perform accent and transliteration compensation functions. It will be appreciated that the extended LTS component 110 may execute the standard LTS module 206 and the localized LTS module 208 concurrently.

In further embodiments, at least one of the standard LTS module 206, the localized LTS module 208, or the localized phoneme database 210 may be replaceable or updatable, e.g., “updateable” modules. In this way, the phoneme conversion accuracy of the extended LTS component 110 may be improved via upgrades or updates.

The extended LTS component 110 may further include the wild card module 212. The wild card module 212 may work cooperatively with the standard LTS module 206 and/or the localized LTS module 208 to provide phonemes for an input letter string 108 that includes at least one wild card symbol (e.g., “*”). In various embodiments, the wild card module 212 may provide one or more phonemes for each wild card symbol. For example, the input string 108 may be “* ai t”. In such an example, the wild card module 212 may generate phoneme sequences that correspond to the words “night”, “light”, “kite”, “knight”, “lite”, etc. In another example, the wild card module 212 may also generate phoneme sequences in which the wild card symbol “*” may be replaced with a plurality of phonemes. Thus, phoneme sequences that correspond to words such as “flight”, “plight”, and “slight” may also be generated. In such embodiments, the wild card module 212 may be configured to provide a predetermined number of phonemes for each wild card symbol in the input letter string 108. The predetermined number of phonemes may be adjusted via a user interface. Thus, the wild card module 212 may generate a plurality of phoneme sequences based on an input string 108 that includes at least one wild card symbol.

### Fast Matching Component

The fast matching component 112 may receive one or more phoneme sequences, such as the query phoneme sequence 120, from the extended LTS component 110. In turn, the fast matching component 112 may identify candidate phoneme sequences, such as candidate phoneme sequences 122, by pruning a pool of potential phoneme sequences. The pool of potential phoneme sequences may include phoneme sequences from one or more language-specific dictionaries 214. In various embodiments, the one or more dictionaries 214 may include a standard dictionary, a technical dictionary, a medical dictionary, and/or other types of general and specialized dictionaries. The fast matching component 112 may include a phoneme constraint module 216, a length constraint module 218, and a phonetic distance module 220.

In at least one embodiment, the fast matching component 112 may use the phoneme constraint module 216 to prune the pool of potential phoneme sequences using the first phoneme in the query phoneme sequence 120 as a guide. For example, but not as a limitation, if the first phoneme in the query phoneme sequence 120 is the phoneme [s], such as in the word “sure”, the phoneme constraint module 216 may prune, that is, eliminate all phoneme sequences in the pool that do not begin with the phoneme [s].

In other embodiments, the phoneme constraint module 216 may prune the pool of potential phoneme sequences based on the first phoneme in the query phoneme sequence 120, but further takes into account other phonemes that are “phonetically related”. For example, but not as a limitation, the first phoneme in the query phoneme sequence 120 may be the phoneme [s], such as in the word “sure”. In such an example, the phoneme constraint module 216 may be further configured to consider the phoneme [sh], such as in the word “shore”, and the phoneme [z], such as in the “zero”, to be “phonetically related” phonemes. Accordingly, the phoneme constraint module 216 may exempt phoneme sequences from the pool that begin with the phonemes [sh] and [z], as well as potential phoneme sequences that begin with the phoneme [s], from being pruned. In other words, in such an example, the potential phoneme sequences extracted from the pool by the phoneme constraint module 216 as candidate phoneme sequences 122 may include phoneme sequences that begin with the phonemes [s], [sh] and [z]. In at least some embodiments, the phoneme constraint module 216 may determine that certain phonemes are “phonetically related” by consulting a pre-determined phonetic correlation table that is replaceable and/or updatable.

The length constraint module 218 may further prune the pool of potential phoneme sequences. In various embodiments, the length constraint module 224 may perform the pruning by eliminating each potential phoneme sequence of the pool with a number of phonemes that are outside of a predetermined range from the number of phonemes in the query phoneme sequence 120. The remaining potential candidate sequences may be designated by the length constraint module 218 as candidate phoneme sequences 122. For example, but not as a limitation, the query phoneme sequence 120 may include a total of 5 phonemes. In such an example, the length constraint module 218 may eliminate those potential phoneme sequences that have less than 3 phonemes or more than 8 phonemes. In other words, in an instance where the query phoneme sequence 120 (as shown in FIG. 1) has 5 phonemes, the length constraint module 218 may perform pruning to retain only potential phoneme sequences with between 3-8 phonemes.

In at least some embodiments, the number of phonemes that is considered to be within the range of the query phoneme sequence 120 by the length constraint module 218 may be adjustable via a replaceable or updatable phoneme length table. In at least one of these embodiments, the range of phonemes may be graduated (e.g., the longer the query phoneme sequence 120, the bigger the range, and vice versa). In other embodiments, the range of phonemes may be explicitly set, i.e., hard coded, in relation to the number of phonemes in the query phoneme sequence 120.

The phonetic distance module 220 may further prune the pool of potential phoneme sequences to eliminate additional irrelevant phoneme sequences to produce candidate phoneme sequences 122. In various embodiments, the phonetic distance module 220 may use a Kullback-Leibler Divergence (KLD) approximation to measure a global phonetic distance between each of the potential phoneme sequence and the query phoneme sequence 120. During the KLD approximation, the phonetic distance module 220 may disregard the phoneme order information of the phonemes in each potential phoneme sequence. Rather, the phonetic distance module 220 may treat the phonemes in each potential phoneme sequence as a group of phonemes to be compared to another group of phonemes. Thus, with the application of the KLD approximation, only one or more potential phoneme sequences with global phonetic distances that are below a predetermined phonetic distance threshold from the query phoneme sequence 120 may survive pruning by phonetic distance module 220.

The phonetic distance between any pair of phonemes, such as a pair of (1) a phoneme of a particular potential phoneme sequence, and (2) a phoneme from the query phoneme sequence 120, may be continuous rather than discrete. Accordingly, the phonetic distance between any pair of phonemes may be pre-computed via the KLD approximation during an offline training phase, rather than during the phoneme sequence elimination. Accordingly, the phonetic distance module 220 may pre-compute a phoneme confusion table 222 that encapsulates the phonetic distance between any pair of phonemes of a language (e.g., English).

For example, there are approximately 42 phonemes in the English language. Thus, in such an example, the phonetic distance module 220 may produce a phoneme confusion table 222 that includes 42-by-42 entries, where in each of the entries lists a particular phoneme distance between a pairing between two phonemes.

In at least one embodiment, the phoneme confusion table 222 may be constructed based on language-specific training data. For example, in an instance where the phonetic suggestion engine 102 is intended for use by Chinese (Mandarin) speaker to obtain English word or phrase suggestions, the training data may be English phonemes as pronounced by one or more Chinese (Mandarin) speakers. In this way, phoneme confusion table 222 may enable the phonetic distance module 220 to account for speech, ethnic, and/or regional pronunciation differences. However, in other embodiments, the phoneme confusion table 222 may include phonetic distances for phonemes of multiple languages and pronounced by different language speakers.

It will be appreciated that in further embodiments, the fast matching component 112 may implement one or more of the modules 216-220 in any combination to obtain the candidate phoneme sequences 122. In other words, the fast matching component 112 may implement one of the modules 216-220, any two of the modules 216-220, or all of the modules 216-220. The modules 216-220 may also be implemented in any order provided that the pruned candidate phoneme sequences 126 from a prior executed module is provided to a subsequently executed module for further pruning

### Scored Matching Component

The refined matching component 114 may receive and process a plurality of candidate phoneme sequences 122, as generated by the fast matching component 112, into the scored phoneme sequences 124. In various embodiments, the refined matching component 114 may perform Dynamic-Programming (DP) sequence alignment between each of the candidate phoneme sequences 122 and the query phoneme sequence 120.

It will be appreciated that DP alignment is a mathematical optimization method that is well suited for finding alignments, that is, similarity, between different sequences of data. Typically, DP alignment may attempt to transform one sequence into another sequence using editing operations that insert, substitute, or delete an element in one of the sequences. Since each insertion, substitution, or deletion operation incurs a cost due to the distance between the two sequences, the DP sequence alignment process may generate a score for each sequence based on such costs. In at least one embodiment, the DP sequence alignment process may be configured such that a higher score may indicate a lower incurred cost, or a higher degree of alignment between two sequences. Conversely, a lower score may indicate a higher incurred cost, or a lower degree of alignment between two sequences.

Thus, the DP sequence alignment process may compare the each of the candidate phoneme sequences 122 and the query phoneme sequence 120, taking into account of the phoneme order of each sequence. Accordingly, The refined matching component 114 may generate a phonetic score for each candidate phoneme sequence 122 that reflects its degree of alignment with the query phoneme sequence 120 (e.g., higher score is indicates greater degree of alignment, and lower score indicates lesser degree of alignment). Thus, the refined matching component 114 may process the pruned candidate phoneme sequences 122 into the scored phoneme sequences 124.

### Ranking Component

The ranking component 116 may rank each of the scored phoneme sequences 124 based on a plurality of factors. These factors may include (1) the phonetic score of each scored phoneme sequences 124, as generated by the refined matching component 114; (2) a spelling score of each scored phoneme sequences 124; and (3) the frequency score of each scored phoneme sequences 124. The ranking of each scored phoneme sequence 124 may represent its likelihood of being the intended spelling of an original input letter string, such as the input letter string 108. Accordingly, the ranking component 116 may further generate a list of ranked phoneme sequences 126.

Thus, the ranking component 116 may include a spelling rank module 224 that provides a spelling score for of each of the scored phoneme sequences 124. However, in order to obtain the spelling score of each phoneme sequence via the spelling rank module 224, the ranking component 116 may first use a conversion module 226 to obtain a word or a phrase that corresponds to each of the scored phoneme sequences 124. In other words, the conversion module 226 may revert each of the score phoneme sequences 124 back to the corresponding word or phrase. For example, if the scored phoneme sequence 124 is the phoneme sequence [f i z i k s], the conversion module 224 may revert the phoneme sequence back to the word “physics.” In various embodiments, the conversion module 226 may consult the dictionaries 214 to perform the reversions.

Upon receiving the reverted words or phrases that correspond to the scored phoneme sequences 124, the spelling rank module 224 may perform DP sequence alignment of the input letter string 108 that is the basis for the generation of the scored phoneme sequences 120 with each reverted word or phrase. The DP sequence alignment may be similar to the DP alignment performed by the scored match component 114. In at least one embodiment, the spelling rank module 224 may have the ability to process wild card symbols.

For example, if the input letter string 108 is the string “fiz*iks”, and one of the reverted words that corresponds to one of the scored phoneme sequences 124 (as derived from the string “fiz*iks”) is “physics”, the spelling rank module 224 may perform DP alignment of “fiz*iks” and “physics”. The DP alignment of fiz*iks” and “physics” may generate a DP alignment distance between the two. The DP alignment distance may be converted into a score (e.g., higher score indicates greater alignment, and lower score indicates lesser degree of alignment). This score may be referred to as the spelling score. In this way, the spelling rank module 224 may generate a spelling score for each scored phoneme sequence 124.

Further, the ranking component 116 may also include a frequency rank module 228 that assigns a frequency score to each scored phoneme sequence 124. More precisely, the frequency score may be assigned based on the word or phrase that corresponds to each scored phoneme sequence 124. Thus, the frequency rank module 228 may also receive the reverted words or phrases that correspond to the scored phoneme sequences 124. Subsequently, the frequency rank module 228 may ascertain a frequency score for each reverted word or phrase using a language-specific language frequency model 230. The frequency score may represent the frequency that each word or phrase appears in a particular language during common usage.

For example, the refined matching component 114 may have produced two scored phoneme sequences 124 from the input string 108. The reversion of the two scored phoneme sequences 124 generated the words “physics” and “phoenix.” By consulting the language frequency model 230, the frequency rank module 228 may determine that the word “physics” is more commonly used in English by a population over a time period than the word “phoenix”. Accordingly, the frequency rank module 228 may assign a higher frequency score to the word “physics” than the word “phoenix.” In other words, the assignment of the frequency scores may indicate that as far as the frequency rank module 228 is concerned, the word “physics” is more likely to be the intended word desired by the user that entered the (misspelled) input string 108 than the word “phoenix.”

In various embodiments, the language frequency model 230 may be updatable or replaceable. For example, the proper name “Obama” may be infrequently used by an English speaking population prior to the election of Barrack Obama as the President of the United States in 2008. However, following the election of President Obama, the use of the proper name “Obama” became much more prevalent. Accordingly, the language frequency model 230 may be updated to reflect its increased usage.

Thus, following processing by the spelling rank module 224 and the frequency rank module 228 of the ranking component 116, each of the scored phoneme sequences 124 may have three different scores: (1) a phonetic score from the refined matching component 114; (2) a spelling score from the spelling rank module 224; and (3) a frequency score from the frequency rank module 228.

As a result, the rank component 116 may use these scores of each scored phoneme sequences 124 to rank the sequences. In some embodiments, the rank component 116 may use linear weighting to combine the scores for each scored phoneme sequence 124. For example, the phonetic score, the spelling score, and the frequency score for each of the scored phoneme sequences 124 may be adjusted so that they have the same weight. Subsequently, the rank component 116 may sum the phonetic score, the spelling score, and the frequency score of phoneme sequence to generate an overall score for each of scored phoneme sequences 124. The rank component 116 may then further rank the scored phoneme sequences 124 based on the overall score of each sequence (e.g., highest score to lowest score) to generate the ranked phoneme sequences 126. In some embodiments, the rank component 116 may further prune the ranked phoneme sequences 126. The pruning may be based on a numerical threshold (e.g., top 5 sequences) sequences, a percentage threshold (e.g., top 50% of the sequences), a score threshold (e.g., sequences having a phonetic score that is above 70 on a 100 scale), or the like.

However, in alternative embodiments, the rank component 116 may obtain the ranked phoneme sequences 126 via stepwise decision making. In such embodiments, the rank component 116 may first rank the scored phoneme sequences 124 according to their phonetic scores (i.e., highest score to lowest score). Subsequently, the rank component 116 may select some of the sequences 124 that are ranked by their phonetic scores. In various embodiments, the selection of the some of the sequences 124 may be based on a numerical threshold (e.g., top 5 sequences) sequences, a percentage threshold (e.g., top 50% of the sequences), a score threshold (e.g., sequences having a phonetic score that is above 70 on a 100 scale), or the like.

Secondly, the pruned phoneme sequences 124 that are selected may be further re-ranked according to their respective spelling scores (e.g., highest score to lowest score). Subsequently, the rank component 116 may further prune the phoneme sequences 124 by their spelling score. In various embodiments, the pruning may be accomplished via the selection of the some of the sequences 124 based on a numerical threshold (e.g., top 5 sequences) sequences, a percentage threshold (e.g., top 50% of the sequences), a score threshold (e.g., sequences having a spelling score that is above 70 on a 100 scale), or the like.

Thirdly, the twice pruned phoneme sequences 124 may be further re-ranked according to their respective frequency scores (e.g., highest score to lowest score). In some embodiments, a further pruning may be accomplished via the selection of the some of the twice pruned sequences 124. The selection may be based on a numerical threshold (e.g., top 5 sequences) sequences, a percentage threshold (e.g., top 50% of the sequences), a score threshold (e.g., sequences having a frequency score that is above 70 on a 100 scale), or the like. In other embodiments, the rank component 116 may skip the last pruning. Thus, by performing the step wise re-ranking and pruning selection, the rank component 116 may generate the ranked phoneme sequences 126 from the scored phoneme sequences 124.

However, in other embodiments, the rank component 116 may implement linear weighting and/or the stepwise decision making to rank the scored phoneme sequences 124 without calculating and implement the spelling scores or the frequency scores. In other words, the rank component 116 may rank the scored phoneme sequences 124 based on (1) the phonetic scores and spelling scores; or (2) the phonetic scores and frequency scores.

Once the rank component 116 has accomplished ranking and/or pruning of the scored phoneme sequences 124, the rank component 116 may further use the conversion module 226 to convert the scored phoneme sequences 124 into words or phrase suggestions 106. For example, in an instance where “fiziks” is the input string, the ranking component 116, may ultimately generate a ranked list of words 106 that includes “physics, physical, physique, phoenix, felix.” The words or phrases in the ranked list may be ranked from the most likely to the least likely, or vice versa. The rank component 116 may further transmit the ranked words or phrase suggestions 106 to a user interface module 232 for display.

### Additional Modules

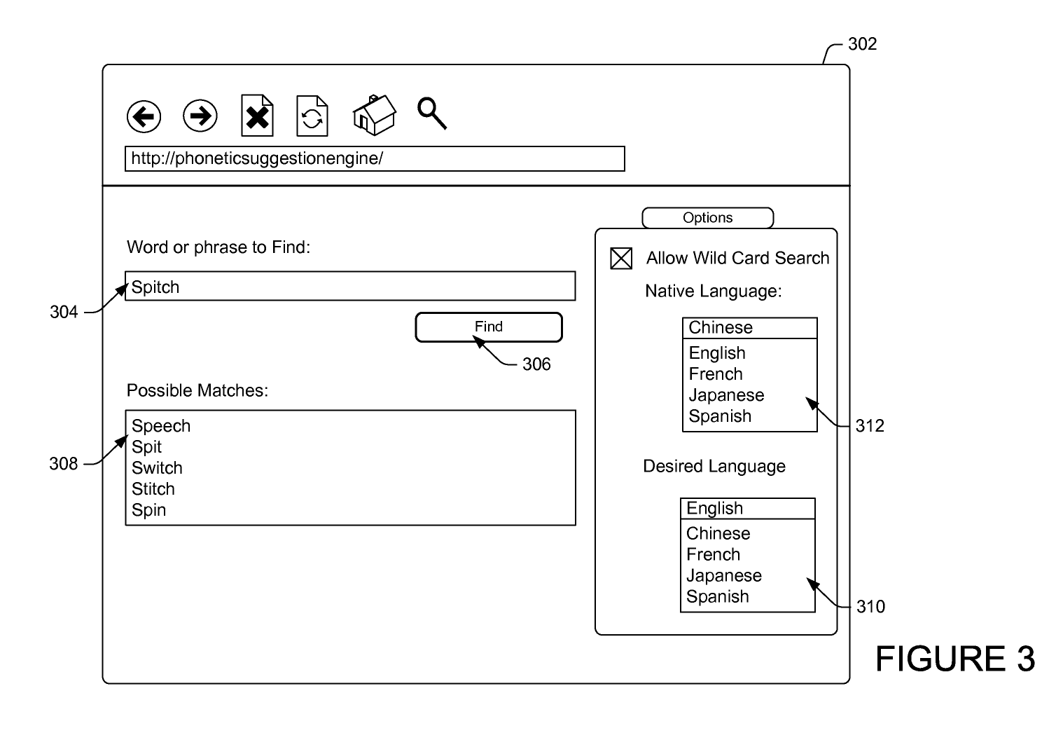

The user interface module 232 may interact with a user via a user interface. The user interface may include a data output device (e.g., visual display, audio speakers), and one or more data input devices. The data input devices may include, but are not limited to, combinations of one or more of keypads, keyboards, mouse devices, touch screens, microphones, speech recognition packages, and any other suitable devices or other electronic/software selection methods. The user interface module 232 may facilitate the entry of one or more input letter strings 108 into the phonetic suggestion engine 102. Further, the user interface module 232 may enable a user to designate a language-specific localized LTS module 206, a language-specific phoneme confusion table 222, one or more language-specific dictionaries 214, and/or a language-specific language frequency model 230. The user interface module 232 may further format the word or phrase suggestions 106 for display on the user interface (e.g., as web objects suitable for display in a web browser, in a standalone dictionary application, a part of a word processing application, and/or the like). An example web page that displayed via the user interface is illustrated in FIG. 3.

FIG. 3 illustrates an example web page 302 that facilitates the provision of word or phrase suggestions for an input letter string. The web page 302 may include an input portion 304 that enables a user to enter an input letter string 108. The user may submit the input letter string 108 to the phonetic suggestion engine 102 by activating a submission button 306. In turn, the phonetic suggestion engine 102 may display word or phrase suggestions 106 in the display portion 308 of the web page 302.

The example web page 302 may further include a desired language portion 310 that enables the user to designate the desired language for the word or phrase suggestions, thus enabling the phonetic suggestion engine 102 to implement the one or more corresponding language-specific dictionaries 214, and/or the corresponding language-specific language frequency model 230. Moreover, the example webpage 302 may also include a native language portion 312 that enables the user to select the user's native language. In turn, the phonetic suggestion engine 102 may implement the corresponding language-specific localized LTS module 206, and/or the corresponding language-specific phoneme confusion table 222. It will be further appreciated that while the native language portion 312 is illustrated in FIG. 3 as including different languages, the native language portion 312 may also include choices for different ethnic or region accents (e.g., “English—Midwest,” “English—Northeastern”, “English—Southern,” and/or the like).

Returning to FIG. 2, the upgrade module 234 may update or replacement of one or more updateable components. These updateable components may include a language-specific localized LTS module 206, a language-specific phoneme confusion table 222, one or more language-specific dictionaries 214, and/or a language-specific language frequency model 230. In various embodiments, the user interface module 232 may receive a designation of the source for a replacement or update to a particular updateable component, and the upgrade module 234 may replace or update the particular updateable component.

### Example Processes

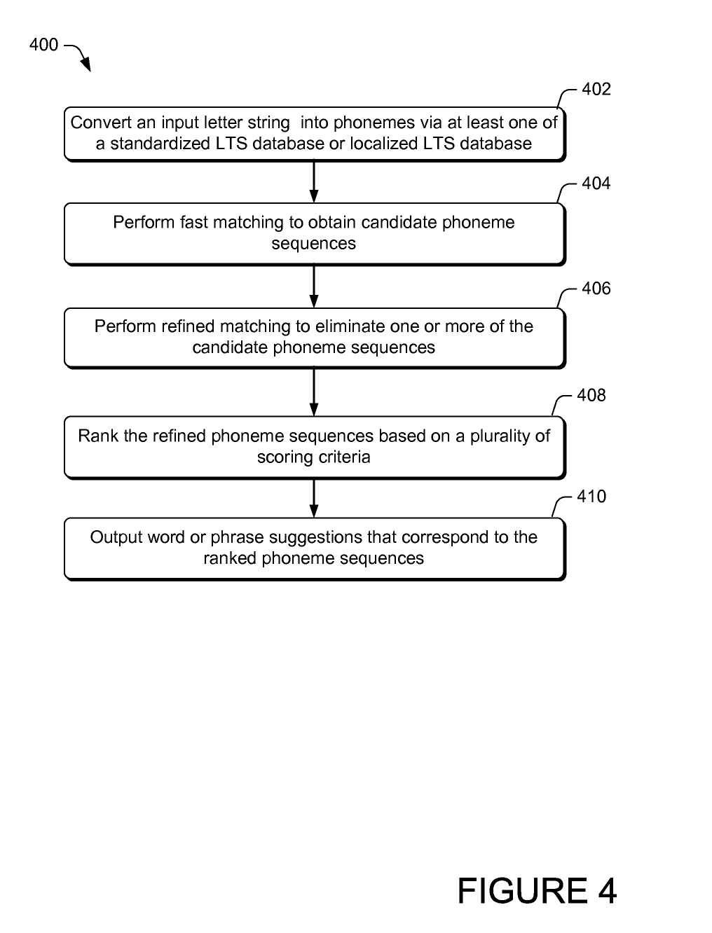

FIGS. 4-6 describe various example processes for implementing the phonetic suggestion engine 102. The order in which the operations are described in each example process is not intended to be construed as a limitation, and any number of the described blocks may be combined in any order and/or in parallel to implement each process. Moreover, the blocks in the FIGS. 4-6 may be operations that can be implemented in hardware, software, and a combination thereof. In the context of software, the blocks represent computer-executable instructions that, when executed by one or more processors, cause one or more processors to perform the recited operations. Generally, computer-executable instructions may include routines, programs, objects, components, data structures, and the like that cause the particular functions to be performed or particular abstract data types to be implemented.

FIG. 4 is a flow diagram that illustrates an example process 400 to generate word or phrase suggestions for an input letter string, in accordance with various embodiments.

At block 402, the phonetic suggestion engine 102 may use the extended LTS component 110 to convert an input letter string 108 into a query phoneme sequence 120. In various embodiments, the extended LTS component 110 may use a language-specific standard LTS module 206, as well as a localized LTS module 208 that accounts for accents and regional pronunciation variations, to convert the input letter string 108 into the query phoneme sequence 120. In further embodiments, the phonetic suggestion engine 102 may use a wild card module 212 to process an input letter string 108 that includes wild card symbols.

At block 404, the phonetic suggestion engine 102 may use a fast matching component 112 to identify a plurality of candidate phoneme sequences 122 from a pool of potential phoneme sequences, such as one or more dictionaries. The fast matching component 112 may use one or more pruning techniques to identify the candidate phoneme sequences 122. In various embodiments, the pruning techniques may include the elimination of irrelevant phoneme sequences based on a first phoneme of the query phoneme sequence 120. The pruning techniques may further include length constraint based on the length of the query phoneme sequence 120, as well by comparing the phonetic distance between the phonemes in the query phoneme sequence 120 and the phonemes in each of the potential phoneme sequences. These pruning techniques may be implemented consecutively or alternatively in different embodiments.

At block 406, the phonetic suggestion engine 102 may perform scored matching to eliminate one or more of the candidate phoneme sequences 122. In various embodiments, the phonetic suggestion engine 102 may use the refined matching component 114 to perform Dynamic Programming (DP) alignment between the candidate phoneme sequences 122 and the query phoneme sequence 120. The DP alignment may generate a phonetic score for each candidate phoneme sequence 122 that indicates its similarity to the query phoneme sequence 120. Based on the phonetic scores, the refined matching component 114 may eliminate one or more phoneme sequences from the candidate phoneme sequences 122 that are farther than a predetermined phonetic distance away from the query phoneme sequence.

At block 408, the phonetic suggestion engine 102 may rank the surviving candidate phoneme sequences 122, or the scored phoneme sequences 124, via the rank component 116. In some embodiments, the ranking component 116 may obtain a linearly weighted score for each of the scored phoneme sequences 124 by combining the phonetic score with a spelling score and a frequency score. The spelling score of each scored phoneme sequence 124 may represent the similarity of the sequence's corresponding word or phrase to the original input letter string 108. The frequency score of each scored phoneme sequence 124 may represent the frequency of that the sequence's corresponding word or phrase is used by a language speaking population. The ranking component 116 may further use the linearly weighted scores of the scored phoneme sequences 124 to rank and/or prune the scored phoneme sequences 124 and generate the ranked phoneme sequences 126.

In other embodiments, the ranking component 116 may use the phonetic scores of the scored phoneme sequences 124, in combination with the spelling scores and/or frequency scores of the scored phoneme sequences 124 to implement at least one of sequence ranking or pruning in a step wise manner. The step wise implementation of the ranking and/or pruning may generate ranked phoneme sequences 126.

At block 410, the ranking component 116 may convert the ranked phoneme sequences 126 into corresponding ranked words or phrases. The ranked words or phrases may be outputted as word or phrase suggestions 106 by the user interface module 232.

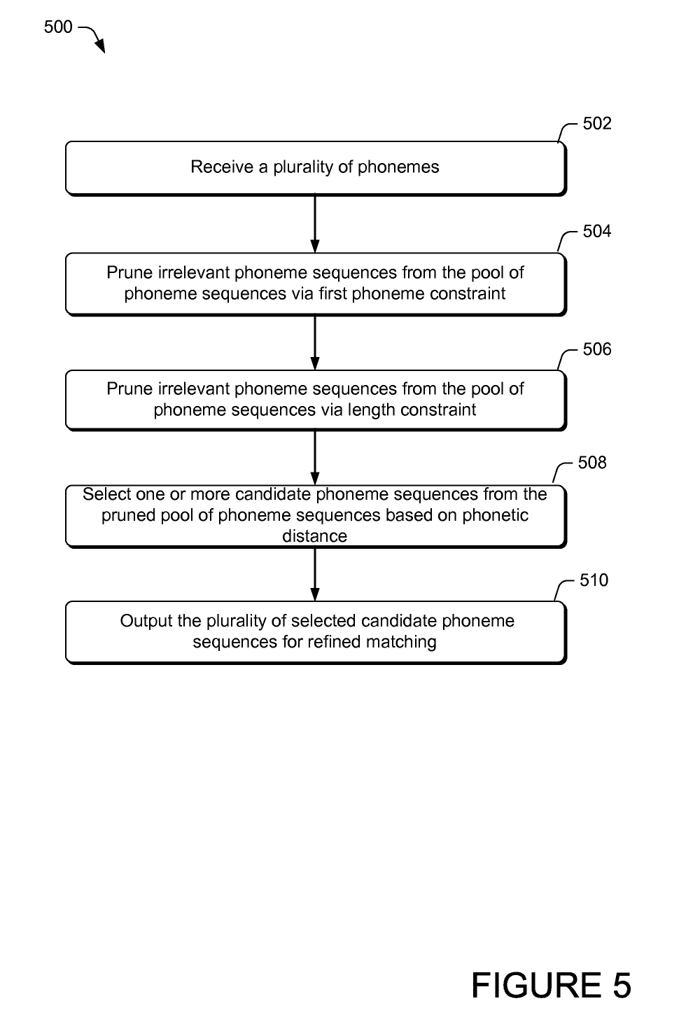

FIG. 5 is a flow diagram that illustrates an example process 500, as performed by the fast matching component 112, to obtain candidate phoneme sequences from a pool of phoneme sequences, in accordance with various embodiments. The example process 500 may further expand upon block 404 of the example process 400.

At block 502, the fast matching component 112 may use a phoneme constraint module 216 to prune irrelevant phoneme sequences from the pool of potential phoneme sequences (e.g., one or more dictionaries). In at least one embodiment, the phoneme constraint module 216 may prune potential phoneme sequences in the pool that does not have the same first phoneme as the query phoneme sequence 120. However, in additional embodiments, the phoneme constraint module may also spare phoneme sequences in the pool with first phonemes that are “phonetically related” to the first phoneme of the query phone sequence 120 from being pruned.

At block 504, the fast matching component 112 may use a length constraint module 218 to prune each phoneme sequence from the pool of potential phoneme sequences with a number of phonemes that are outside of a predetermined range of the number of phonemes in the query phoneme sequence 120.

At block 506, the fast matching component 112 may use a phonetic distance module 220 to select a plurality of candidate phoneme sequences 122 from the pruned pool of potential phoneme sequences. The phonetic distance module 220 may make a selection by using the global phonetic distance between the phonemes in the query phoneme sequence 120 and the phonemes in each of the candidate phoneme sequences 122. Thus, the phonetic distance module 220 may select as candidate phoneme sequences 122 those phoneme sequences in the pool with global distances than are smaller than a predetermined distance. In various embodiments, the phonetic distance module 220 may pre-compute and use a phoneme confusion table 222 that encapsulates the phonetic distance between any pair of phonemes of a language during the selection.

At block 508, the fast matching component 112 may output the plurality of selected candidate phone sequences for further processing by the refined matching module 114. In other embodiments of the process 500, the fast matching component 116 may execute a one or two of the blocks 504-506 rather than each of the blocks 504-506.

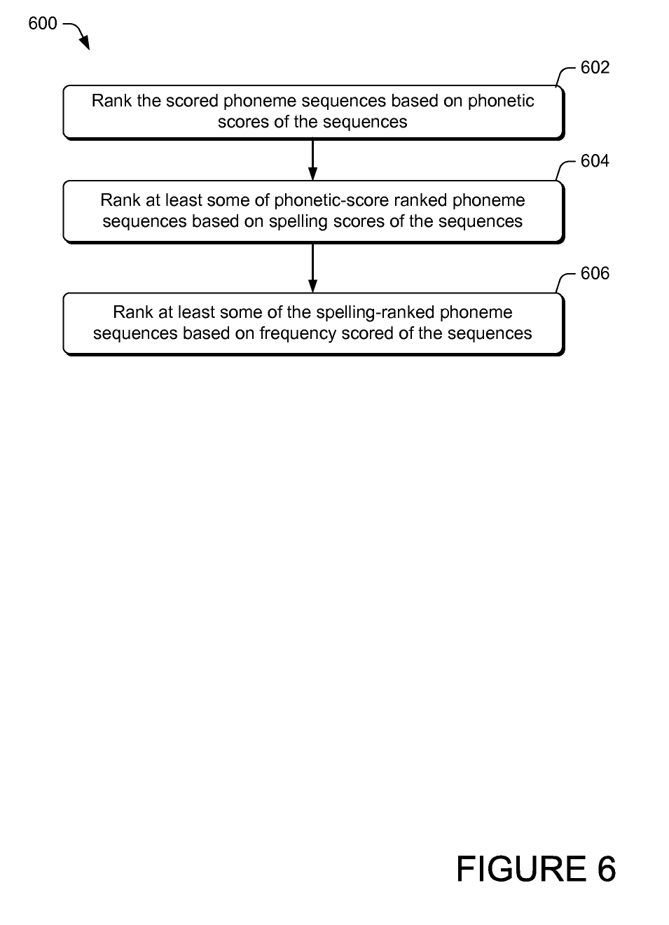

FIG. 6 is a flow diagram that illustrates an example process 600 to rank the scored phoneme sequences 124 using at least one scoring criteria, in accordance with various embodiments. The example process 600 is a step wise process for ranking and pruning the scored phoneme sequences 124 so that the scored phoneme sequences 124 may be eventually outputted as word or phrase suggestions 106. The example process 600 may further expand upon block 408 of the example process 400.

At block 602, the ranking component 116 may rank the scored phoneme sequences 124 based on phonetic scores of the sequences. The phonetic scores may be generated via DP alignment, and indicate a degree of similarity of each scored phoneme sequence 124 to the query phoneme sequence 120. In some embodiments, the scored phoneme sequences 124 may be ranked from highest phonetic score to the lowest phonetic score. In at least one embodiment, some of ranked sequences 124 may be selected following such phonetic score ranking. The selection of the some of the sequences 124 may be based on a numerical threshold (e.g., top 5 sequences) sequences, a percentage threshold (e.g., top 50% of the sequences), a score threshold (e.g., sequences having a phonetic score that is above 70 on a 100 scale), or the like. Accordingly, the remaining ranked sequences 124 may be pruned.

At block 604, the ranking component 116 may rank at least some of the phonetic scored-ranked phoneme sequences 124, or sequences that are selected during block 502, based on spelling scores of the sequences. In various embodiments, the spelling score of the selected phoneme sequences 124 may be derived by first reverting the selected sequences 124 into their corresponding word or phrase, and then performing DP alignment between each reverted word or phrase and the input letter string 108. The DP alignment may provide a degree of similarity between a letter sequence of each word or phrase and a letter sequence of the input letter string 108. In this way, the ranking component 116 may generate a spelling score for each of the selected sequences 124 that represent its letter sequence degree of similarity.

Subsequently, the at least some of phonetic-scored ranked phoneme sequences 124 may be further ranked according to the spelling scores. In at least one embodiment, some of ranked sequences 124 may be selected following such spelling score ranking The selection of some of the sequences 124 may be based on a numerical threshold (e.g., top 5 sequences) sequences, a percentage threshold (e.g., top 50% of the sequences), a score threshold (e.g., sequences having a phonetic score that is above 70 on a 100 scale), or the like. Accordingly, the remaining ranked sequences 124 may be once again pruned.

At block 606, the ranking component 116 may rank at least some of the spelling score-ranked phoneme sequences 124, or sequences that are selected during block 604, based on frequency scores of the sequences. The frequency score of each phoneme sequence 124 may represent the frequency that the sequence's corresponding word or phrase is used by a language speaking population. In various embodiments, the frequency score of each phoneme sequence 124 may be determined via a language frequency model 230. The frequency score ranked phoneme sequences 124 may be outputted as ranked phoneme sequences 126.

However, in at least one embodiment, some of ranked sequences 124 may be further selected following such spelling score ranking. The selection of the some of the sequences 124 may be based on a numerical threshold (e.g., top 5 sequences) sequences, a percentage threshold (e.g., top 50% of the sequences), a score threshold (e.g., sequences having a phonetic score that is above 70 on a 100 scale), or the like. Accordingly, the remaining ranked sequences 124 may be once again pruned. In such embodiments, the frequency score ranked phoneme sequences 124, after undergoing such pruning, may be outputted as ranked phoneme sequences 126.

Example Electronic device

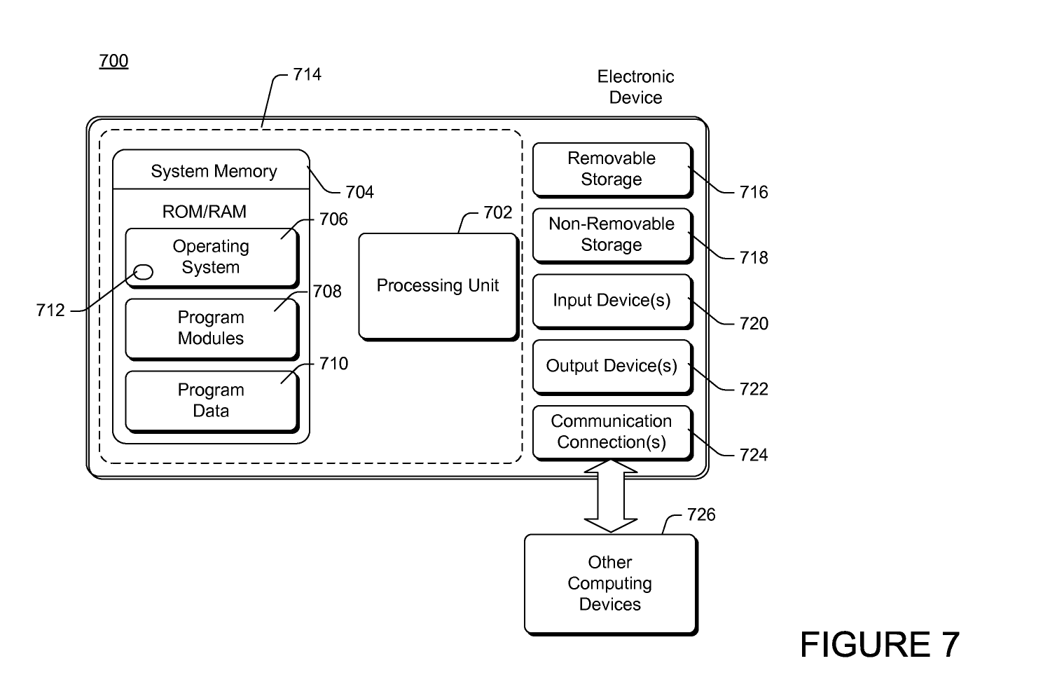

FIG. 7 illustrates a representative electronic device 700 that may be used to implement a phonetic suggestion engine 102 that provides the word or phrase suggestions 106. However, it will readily appreciate that the techniques and mechanisms may be implemented in other electronic devices, systems, and environments. The electronic device 700 shown in FIG. 7 is only one example of an electronic device and is not intended to suggest any limitation as to the scope of use or functionality of the computer and network architectures. Neither should the electronic device 700 be interpreted as having any dependency or requirement relating to any one or combination of components illustrated in the example electronic device.

In at least one configuration, electronic device 700 typically includes at least one processing unit 702 and system memory 704. Depending on the exact configuration and type of electronic device, system memory 704 may be volatile (such as RAM), non-volatile (such as ROM, flash memory, etc.) or some combination thereof. System memory 704 may include an operating system 706, one or more program modules 708, and may include program data 710. The operating system 706 includes a component-based framework 712 that supports components (including properties and events), objects, inheritance, polymorphism, reflection, and provides an object-oriented component-based application programming interface (API), such as, but by no means limited to, that of the .NET™ Framework manufactured by the Microsoft® Corporation, Redmond, Wash. The electronic device 700 is of a very basic configuration demarcated by a dashed line 714. Again, a terminal may have fewer components but may interact with a electronic device that may have such a basic configuration.

Electronic device 700 may have additional features or functionality. For example, electronic device 700 may also include additional data storage devices (removable and/or non-removable) such as, for example, magnetic disks, optical disks, or tape. Such additional storage is illustrated in FIG. 7 by removable storage 716 and non-removable storage 718. Computer storage media may include volatile and nonvolatile, removable and non-removable media implemented in any method or technology for storage of information, such as computer readable instructions, data structures, program modules, or other data. System memory 704, removable storage 716 and non-removable storage 718 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by Electronic device 700. Any such computer storage media may be part of device 700. Electronic device 700 may also have input device(s) 720 such as keyboard, mouse, pen, voice input device, touch input device, etc. Output device(s) 722 such as a display, speakers, printer, etc. may also be included.

Electronic device 700 may also contain communication connections 724 that allow the device to communicate with other electronic devices 726, such as over a network. These networks may include wired networks as well as wireless networks. Communication connections 724 are some examples of communication media. Communication media may typically be embodied by computer readable instructions, data structures, program modules, etc.

It is appreciated that the illustrated electronic device 700 is only one example of a suitable device and is not intended to suggest any limitation as to the scope of use or functionality of the various embodiments described. Other well-known electronic devices, systems, environments and/or configurations that may be suitable for use with the embodiments include, but are not limited to personal computers, server computers, hand-held or laptop devices, multiprocessor systems, microprocessor-base systems, set top boxes, game consoles, programmable consumer electronics, network PCs, minicomputers, mainframe computers, distributed computing environments that include any of the above systems or devices, and/or the like.

The implementation of a phonetic suggestion engine may enable the non-native speakers and/or language learners of a particular language to leverage their phonetic knowledge to obtain the proper spelling of a desired word of the particular language. The phonetic suggestion engine may also augment conventional spelling checkers to enhance language learning and expression.

### CONCLUSION

In closing, although the various embodiments have been described in language specific to structural features and/or methodological acts, it is to be understood that the subject matter defined in the appended representations is not necessarily limited to the specific features or acts described. Rather, the specific features and acts are disclosed as exemplary forms of implementing the claimed subject matter.

1. A computer readable medium storing computer-executable instructions that, when executed, cause one or more processors to perform acts comprising:
converting an input letter string into at least one query phoneme sequence via at least a standardized letter-to-sound (LTS) database;
obtaining a plurality of candidate phoneme sequences that are phonetically similar to the at least one query phoneme sequence from a pool of potential phoneme sequences;
pruning at least some of the candidate phoneme sequences from the plurality of candidate phoneme sequences to generate scored phoneme sequences, each of the pruned candidate phoneme sequences having a phonetic distance to the at least one query phoneme sequence that is greater than a phonetic distance threshold;
generating a plurality of ranked word or phrase suggestions based on the scored phoneme sequences; and
outputting the plurality of ranked word or phrase suggestions.

2. The computer readable medium of claim 1, wherein the converting includes covering an input letter string that includes a wild card symbol into a plurality of query phoneme sequences.

3. The computer readable medium of claim 1, wherein the converting further comprises converting the input letter string via a localized LTS database that accounts for at least one of variations in pronunciation that is encompassed in the input letter string or a transliteration that is encompassed in the input letter string.

4. The computer readable medium of claim 1, wherein the pool of potential phoneme sequences includes one or more dictionaries.

5. The computer readable medium of claim 1, wherein the obtaining comprises one or more of:
selecting a phoneme sequence that has an initial phoneme that is phonetically identical or phonetically related to an initial phoneme of the at least one query phoneme sequence as one of the plurality of candidate phoneme sequences;
selecting a potential phoneme sequence having a number of phonemes that is within a range of a number of phonemes in the at least one query phoneme sequence as one of the plurality of candidate phoneme sequences; or
selecting a potential phoneme sequence having a global phonetic distance that is farther than a predetermined threshold distance from the at least one query phoneme sequence as one of the plurality of candidate phoneme sequences.

6. The computer readable medium of claim 5, wherein the selecting a potential phoneme sequence having a global phonetic distance that is farther than a predetermined threshold includes pre-computing a phoneme confusion table and calculating the global phonetic distance based on the phoneme confusion table via a Kullback-Leibler divergence (KLD) approximation.

7. The computer readable medium of claim 1, wherein the pruning includes calculating the phonetic distance between each candidate phoneme sequence and the at least one query phoneme sequence via a Dynamic Programming (DP)-based sequence alignment.

8. The computer readable medium of claim 1, wherein the pruning includes deriving a phonetic score for each candidate phoneme sequence that represents the phonetic distance between a corresponding candidate phoneme sequence and the at least one query phoneme sequence via a Dynamic Programming (DP)-based sequence alignment.

9. The computer readable medium of claim 1, wherein the generating comprises:
deriving a spelling score for each scored phoneme sequence based on similarity between a letter sequence of each scored phoneme sequence and a letter sequence of the input letter string via a Dynamic Programming (DP)-based sequence alignment;
deriving a frequency score for each scored phoneme sequence via a language frequency model that indicates use a prevalence of the each scored phoneme sequence;
obtaining a combined score for each scored phoneme sequence, the combined score including a corresponding phonetic score, a corresponding spelling score, and a corresponding frequency score;
ranking the scored phoneme sequences based on the combined score of each scored phoneme sequence; and
converting the ranked and scored phoneme sequences into the plurality of ranked word or phrase suggestions

10. The computer readable medium of claim 9, wherein the ranking further includes eliminating at least one the scored phoneme sequences with a corresponding combined score that is below a predetermined threshold.

11. The computer readable medium of claim 1, wherein the generating comprises:
ranking the scored phoneme sequences based on the phonetic score of each scored phoneme sequence;
pruning at least one of the scored phoneme sequences with a corresponding phonetic score that is below a predetermined threshold; and
converting the pruned scored phoneme sequences into the plurality of ranked word or phrase suggestions.

12. The computer readable medium of claim 1, wherein in the generating further comprises:
ranking the scored phoneme sequences based on the phonetic score of each scored phoneme sequence;
pruning at least one of the scored phoneme sequences with a corresponding phonetic score that is below a predetermined threshold;
ranking remaining scored phoneme sequences based on a spelling score or frequency score of each pruned and scored phoneme sequence;
pruning at least one of the remaining scored phoneme sequences with the corresponding spelling score or corresponding the frequency score that is below a predetermined threshold; and
converting the pruned and scored phoneme sequences into the plurality of ranked word or phrase suggestions.

13. The computer readable medium of claim 1, wherein the generating comprises:
ranking the scored phoneme sequences based on the phonetic score of each scored phoneme sequence; and
deriving a spelling score for each scored phoneme sequence based on similarity between a letter sequence of each scored phoneme sequence and a letter sequence of the input letter string;
ranking the scored phoneme sequences based on the spelling score of each scored phoneme sequence;
deriving a frequency score for each scored phoneme sequence via a language frequency model that indicates use prevalence of the each scored phoneme sequence;
ranking the scored phoneme sequences based on the frequency score of each scored phoneme sequence; and
converting the ranked and scored phoneme sequences into the plurality of ranked word or phrase suggestions.

14. A computer implemented method, comprising:
converting an input letter string into at least one query phoneme sequence via at least a standardized letter-to-sound (LTS) database;
obtaining a plurality of candidate phoneme sequences that are phonetically similar to the at least one query phoneme sequence from a pool of potential phoneme sequences;
pruning at least some of the candidate phoneme sequences from the plurality of candidate phoneme sequences to generate scored phoneme sequences, each of the candidate phoneme sequences being pruned having a phonetic distance to the at least one query phoneme sequence that is greater than a phonetic distance threshold; and
ranking the scored phoneme sequences based on corresponding phonetic scores and at least one of corresponding spelling scores or corresponding frequency scores; and
generating a plurality of word or phrase suggestions based on the ranked scored phoneme sequences.

15. The computer implemented method of claim 14, wherein the converting further comprises converting the input letter string via a localized LTS database that accounts for at least one of variations in pronunciation that is encompassed in the input letter string or a transliteration that is encompassed in the input letter string.

16. The computer implemented method of claim 14, wherein the converting includes covering an input letter string that includes a wild card symbol into a plurality of query phoneme sequences.

17. The computer implemented method of claim 14, wherein the obtaining comprises one or more of:
selecting a phoneme sequence that has an initial phoneme that is phonetically identical or phonetically related to an initial phoneme of the at least one query phoneme sequence as one of the plurality of candidate phoneme sequences;
selecting a potential phoneme sequence having a number of phonemes that is within a range of a number of phonemes in the at least one query phoneme sequence as one of the plurality of candidate phoneme sequences; or
selecting a potential phoneme sequence having a global phonetic distance that is farther than a predetermined threshold distance from the at least one query phoneme sequence as one of the plurality of candidate phoneme sequences.

18. The computer implemented method of claim 14, wherein the ranking comprises:
ranking the scored phoneme sequences based on the phonetic score of each scored phoneme sequence; and
deriving a spelling score for each scored phoneme sequence based on similarity between a letter sequence of each scored phoneme sequence and a letter sequence of the input letter string via a Dynamic Programming (DP)-based sequence alignment;
ranking the scored phoneme sequences based on the spelling score of each scored phoneme sequence;
deriving a frequency score for each scored phoneme sequence via a language frequency model that indicates a use prevalence of the each scored phoneme sequence; and
ranking the scored phoneme sequences based on the frequency score of each scored phoneme sequence.

19. The computer implemented method of claim 14, wherein the ranking comprises:
deriving a spelling score for each scored phoneme sequence based on similarity between a letter sequence of each scored phoneme sequence and a letter sequence of the input letter string via a Dynamic Programming (DP)-based sequence alignment;
deriving a frequency score for each scored phoneme sequence via a language frequency model that indicates use prevalence of the each scored phoneme sequence;
obtaining a combined score for each scored phoneme sequence, the combined score including a corresponding phonetic score, a corresponding spelling score, and a corresponding frequency score; and
ranking the scored phoneme sequences based on the combined score of each scored phoneme sequence.

20. A system, comprising:
one or more processors;
a memory that includes components that are executable by the one or more processors, the components comprising:
an extended letter-to-sound (LTS) component to convert an input letter string into at least one query phoneme sequence via a standardized LTS database and a localized LTS database that accounts for at least one variation in pronunciation that is encompassed in the input letter string or a transliteration that is encompassed in the input letter string;
a fast matching component to obtain a plurality of candidate phoneme sequences that are phonetically similar to the at least one query phoneme sequence from a pool of potential phoneme sequences via Dynamic Programming (DP)-based sequence alignment;
a scored matching component to prune at least some of the candidate phoneme sequences from the plurality of candidate phoneme sequences and generate scored phoneme sequences, each of the pruned candidate phoneme sequences having a phonetic distance to the at least one query phoneme sequence that is greater than a phonetic distance threshold; and
a ranking component to generate a plurality of ranked word or phrase suggestions based on the scored phoneme sequences.
